(19) United States
(12) Patent Application Publication
(10) Pub. No.: US 2020/0301065 A1
(43) Pub. Date: Sep. 24, 2020

(54) MULTI-CORE OPTICAL FIBER

(71) Applicants: Malcolm H. Hodge, (US); John SHANNON, Phoenix, AZ (US)

(72) Inventors: Malcolm H. Hodge, (US); John SHANNON, Phoenix, AZ (US)

(21) Appl. No.: 16/086,208

(22) PCT Filed: Mar. 17, 2017
(86) PCT No.: PCT/US17/23004

§ 371 Date: Sep. 18, 2018

Related U.S. Application Data
(60) Provisional application No. 62/310,402, filed on Mar. 18, 2016.
(60) Provisional application No. 62/310,442, filed on Mar. 18, 2016.

(51) Int. Cl. G02B 6/02; G02B 6/44; C03B 37/012

(52) U.S. Cl. CPC G02B 6/02042; C03B 37/01222; G02B 6/4433; G02B 6/4478

(57) ABSTRACT

A multi-core optical fiber includes a plurality of optical waveguides that are at least partially fused to an adjacent optical waveguide. At least some of the optical waveguides are aligned to form a linear array having a major axis generally parallel to the linear array and a minor axis generally perpendicular to the major axis. A linear support structure is fused to the linear array of optical waveguides. A buffer engages and surrounds the outer perimeter defined by the optical waveguides and the linear support structure. The buffer has a buffer modulus of elasticity substantially less than the waveguide modulus of elasticity.

### RELATED APPLICATIONS

This patent application claims the benefit of U.S. provisional patent application Ser. No. 62/310,402, filed Mar. 18, 2016, and U.S. provisional patent application Ser. No. 62/310,442, filed Mar. 18, 2016, both of which are incorporated herein by reference.

### TECHNICAL FIELD

This disclosure relates generally to optical fibers and, more particularly, to an optical fiber having multiple cores, which may be referred to as a multi-core optical fiber.

### DESCRIPTION OF RELATED ART

Multi-core optical fibers have been developed to increase the signal carrying capacity of traditional single-core optical fibers. Such multi-core optical fibers include a plurality of optical waveguides surrounded and supported by a silica support tube that encircles the waveguides. In some instances, the silica support tube may have optical characteristics matching that of the cladding of each waveguide. A buffer layer surrounds and protects the support tube. Examples of multi-core optical fibers are disclosed in U.S. Pat. No. 6,154,594.

In addition to greater signal carrying capacity, multi-core optical fibers also result in space savings because the waveguides are more closely positioned as compared to a plurality of individual optical fibers. This configuration may permit additional space savings when used with lasers and/or detectors that are configured to operate on the reduced spacing of the cores of the multi-core fiber.

While multi-core optical fibers increase the density of the waveguides, such structure may increase the crosstalk between adjacent cores. Such a potential increase in crosstalk may require additional physical structure or crosstalk compensation schemes within the optical system to decrease the crosstalk to an acceptable level. In addition, bending of the cores may occur in an inconsistent manner resulting in inconsistent signal carrying characteristics.

While multi-core optical fibers increase the density of the waveguides, such structure also increases the complexity of the optical fiber termination process. More specifically, the larger number of optical waveguides carried within the small cross-section of a single optical fiber increases the complexity of optical termination. An active process that sends light through a plurality of the waveguides may be required to determine their positions. This increases the time, complexity, and cost of terminating such multi-core optical fibers.

### SUMMARY

In one aspect, a multi-core optical fiber includes a plurality of optical waveguides. Each optical waveguide has a length, a core and a cladding layer surrounding the core, and each optical waveguide is at least partially fused to an adjacent optical waveguide along the length thereof. At least some of the optical waveguides are aligned to form a linear array and the linear array has a major axis generally parallel to the linear array and a minor axis generally perpendicular to the major axis. A linear support structure is fused to the linear array of optical waveguides along the length of the optical waveguides. The optical waveguides and the linear support structure define an outer perimeter and a buffer engages and surrounds the outer perimeter. The buffer has a buffer modulus of elasticity substantially less than a waveguide modulus of elasticity of each of the waveguides.

In another aspect, a multi-core optical fiber includes a plurality of silica rods. Each rod is at least partially fused to an adjacent rod along a length thereof, and at least some of the rods are optical rods having a core and a cladding surrounding the core to define an optical waveguide. At least some of the optical waveguides form a linear array of optical waveguides having a major axis generally parallel to the linear array and a minor axis generally perpendicular to the major axis. The silica rods define an outer cross-sectional perimeter with at least a portion of the outer cross-sectional perimeter being defined by at least some of the optical rods. A buffer engages and surrounds the outer cross-sectional perimeter. The buffer has a buffer modulus of elasticity substantially less than a rod modulus of elasticity of each of the silica rods.

In still another aspect, a multi-core glass optical fiber includes a plurality of glass optical waveguides. Each optical waveguide has a length, a core and a cladding layer. The cladding layer has an annular cross section surrounding and co-axial with its core. Each optical waveguide is at least partially fused to an adjacent optical waveguide along the length thereof with at least some of the optical waveguides aligned to form a linear array. The linear array has a major axis generally parallel to the linear array and a minor axis generally perpendicular to the major axis. A glass linear support structure is fused to the linear array of optical waveguides along the length of the optical waveguides and along a side of the linear array and generally parallel to the major axis. The optical waveguides and the linear support structure define an outer perimeter and the optical fiber is devoid of a glass support tube encircling the outer perimeter. A buffer engages and surrounds the outer perimeter. The buffer has a buffer modulus of elasticity substantially less than a waveguide modulus of elasticity of each of the waveguides.

### BRIEF DESCRIPTION OF THE DRAWINGS

The organization and manner of the structure and operation of the Present Disclosure, together with further objects and advantages thereof, may best be understood by reference to the following Detailed Description, taken in connection with the accompanying Figures, wherein like reference numerals identify like elements, and in which:

FIG. 1 is a perspective view of a multi-core optical fiber according to an embodiment of the present disclosure;

FIG. 2 is an enlarged end view of the array of the multi-core optical fiber of FIG. 1;

FIG. 3 is an end view of a second embodiment of a multi-core optical fiber;

FIG. 4 is an end view of a third embodiment of a multi-core optical fiber;

FIG. 5 is an end view of a fourth embodiment of a multi-core optical fiber;

FIG. 6 is an end view of a fifth embodiment of a multi-core optical fiber;

FIG. 7 is an end view of a preform that may be used to form the multi-core optical fiber of FIG. 1;

FIG. 8 is an end view of a sixth embodiment of a multi-core optical fiber;

FIG. 9 is an end view of a seventh embodiment of a multi-core optical fiber; and

FIG. 10 is an end view of an eighth embodiment of a multi-core optical fiber.

### DETAILED DESCRIPTION

While the Present Disclosure may be susceptible to embodiment in different forms, there is shown in the Figures, and will be described herein in detail, specific embodiments, with the understanding that the Present Disclosure is to be considered an exemplification of the principles of the Present Disclosure, and is not intended to limit the Present Disclosure to that as illustrated.

As such, references to a feature or aspect are intended to describe a feature or aspect of an example of the Present Disclosure, not to imply that every embodiment thereof must have the described feature or aspect. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the embodiments illustrated in the Figures, representations of directions such as up, down, left, right, front and rear, used for explaining the structure and movement of the various elements of the Present Disclosure, are not absolute, but relative. These representations are appropriate when the elements are in the position shown in the Figures. If the description of the position of the elements changes, however, these representations are to be changed accordingly.

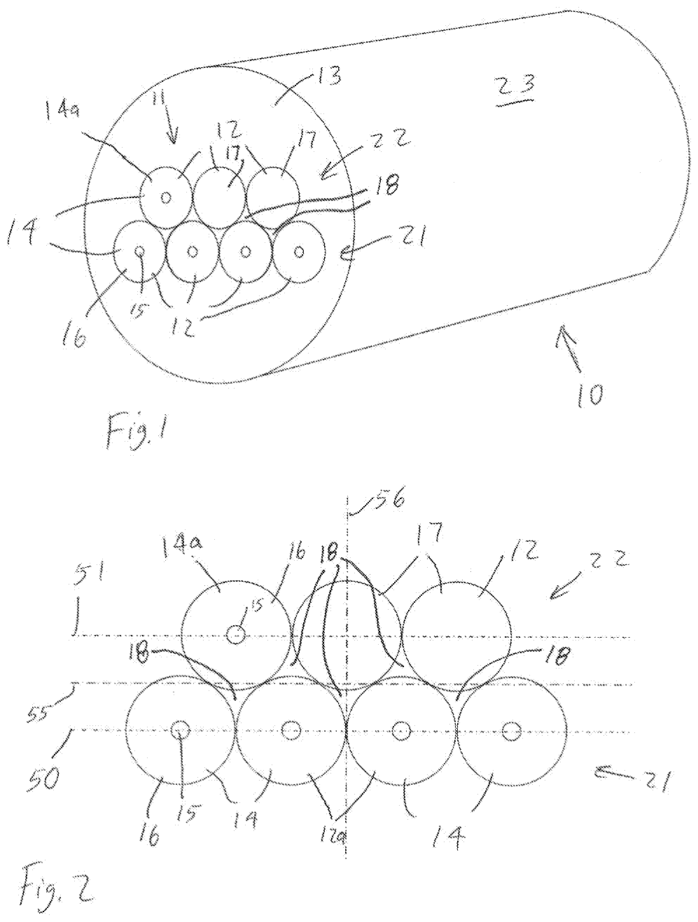

FIG. 1 depicts a multi-core optical fiber 10 drawn from a preform as described below and is known in the art. Optical fiber 10 includes an array 11 of rods 12 surrounded or encircled by a buffer 13. Some of the rods 12 function as optical rods or waveguides 14 and include a core 15 and a cladding or cladding layer 16 that surrounds the core. Others of the rods 12 function as support rods or members 17 that mechanically interact with the optical waveguides 14 to assist in accurately positioning the optical waveguides within the array 11.

As seen in FIGS. 1-2, the core 15 of each optical waveguide 14 has a circular cross-section and the cladding layer 16 has an annular cross-section that surrounds and is co-axial with the core. Each of the core 15 and the cladding 16 may be made of glass, a polymer, or any other desired material provided that light will travel through the core 15 of each optical waveguide 14 as desired. To do so, the index of refraction of the core 15 is greater than the index of refraction of the cladding 16. The core 15 and cladding 16 may be dimensioned or configured so that the optical waveguide 14 functions in any manner such as a single-mode, a multi-mode, or a few- or oligo-mode waveguide.

In many instances, both the core 15 and the cladding 16 may be made primarily of silica. The refractive index of the core 15 and/or cladding 16 may be changed by adding elements such as by doping to change the optical characteristics of the silica. For example, the refractive index may be increased by adding elements having a higher atomic mass than silica such as germanium or phosphorous. In other instances, the refractive index may be reduced by adding elements having a lower atomic mass than silica such as fluorine. In still other instances, the core 15 and cladding may be made from other types of glass such as borosilicate and other elements may be used for changing the refractive indices.

The support rods 17 are depicted with a circular cross-section in FIGS. 1-2 and may be made of the same base material as the optical waveguides 14 so as to have the same melting temperature. In other words, if the optical waveguides 14 have a base material (without doping) of silica, the support rods 17 may also be made of silica. The support rods 17 do not include a cladding layer and thus are not capable of or are unsuitable for the efficient transmission of light as required for an optical waveguide. As such, the support rods 17 do not need to be doped during the process of forming a preform as described below. The support rods 17 may be formed of any material that will provide the desired support for the optical waveguides 14 during and after the forming process.

The rods 12 are configured so as to form a first row 21 of rods aligned along line 50 (FIG. 2) and form a linear array. A second row 22 of rods 12 are aligned along line 51 to form a second linear array that is offset from line 50 and has one fewer rod 12 as compared to first row 21. The rods 12 of the second row 22 are positioned adjacent to but offset from the first row 21, with the center of each rod 12 of the second row being aligned with the intersection of each pair of rods 12 of the first row. Similarly, the center of the interior rods (designated 12a) of the first row 21 are aligned with the intersection of each pair of rods 12 of the second row 22. Such a closely packed array of rods is sometimes referred to as a hexagonal close packed array.

As depicted, the rods 12 of the first row 21 are all configured as optical waveguides 14 to create or define a linear array of optical waveguides. The rods 12 of the second row 22 create or define a linear support structure.

One of the rods 12 of the second row 22 is configured as polarization waveguide 14a and the others are configured as support rods 17. Other combinations of rods 12 making up the second row 22 are contemplated. The polarization waveguide 14a of the second row 22 may function as an orienting or polarization waveguide. More specifically, the polarization waveguide 14a is located in a predetermined position along the second row to establish or identify the order of the waveguides 14 within the first row 21. Determining which of the rods 12 within the second row 22 is the polarizing waveguide 14a will assist in positioning the optical fiber 10 relative to another component (not shown) so that each of the waveguides 14 in the first row 21 is aligned as desired with respect to the other component. If desired, the polarization waveguide 14a of the second row may be omitted and other techniques or structures for polarization may be used or the optical fiber 10 may not include any polarization.

As a result of the drawing process described below, each rod 12 is fused to each of the adjacent rods along the entire length of each rod at each intersection between the rods. Since at least some of the rods 12 have a circular cross-section, the round rods are only partially fused to the adjacent rods as a result of the interstitial air gaps 18 between adjacent rods. By positioning the rods 12 of the first row 21 and the second row 22 in a hexagonal close packed array, a very stable array of rods 12 is formed. In other words, by aligning the center of each rod 12 of the second row 22 with the intersection of each pair of rods 12 of the first row 21 and aligning the center of each interior rod 12a of the first row 21 with the intersection of each pair of rods 12 of the second row 22, the array as drawn is sufficiently stable so that the rods 12 maintain their precise positioning during and after the forming process without the need for an external support member such as a glass or silica tubular support structure used with prior art multi-core optical fibers.

As best seen in FIG. 2, the drawn array or structure 11 is devoid of a glass tubular support structure surrounding the outer perimeter and thus has an asymmetrical cross-section. This asymmetrical configuration has a major axis 55 generally parallel to the lines 50 and 51 and a minor axis 56 generally perpendicular to the major axis. Such an asymmetrical configuration (i.e., without a silica tubular support structure) is primarily flexible or has greater flexibility along the minor axis 56 and is substantially less flexible along the major axis 55.

Referring back to FIG. 1, buffer 13 surrounds and protects the array 11. Since the array 11 does not have a glass support structure encircling it, the buffer 13 engages the exposed outer perimeter of the array 11 (i.e., the outer arcuate surfaces of the rods 12). Buffer 13 may have a circular cross-sectional outer surface 23. Other outer surface configurations such as an oval cross-sectional outer surface (not shown) are contemplated. Buffer 13 may be formed of resin such as a UV cured acrylate material. Other materials are contemplated. If desired, an additional layer of material (not shown) such as a harder layer of UV cured resin material may also be applied to the buffer 13.

Buffer 13 has a modulus of elasticity that is substantially less than the modulus of elasticity of the rods 12. For example, if buffer 13 is formed of a UV cured acrylate resin or material, it will have a modulus of elasticity of approximately 40,000 psi. Rods 12 formed of silica (including those doped with various elements) will have a modulus of elasticity of approximately 10⁷ psi. Due to the substantially lower modulus of elasticity of the buffer as compared to that of the rods 12, the flexibility of the optical fiber 10 will not be significantly limited by the buffer. In other words, the addition of buffer 13 will not materially affect the flexibility of the array 11 and thus the optical fiber 10 will have significant flexibility in a direction generally along or parallel to the minor axis 56 of array 11 and be substantially less flexible in a direction generally along or parallel to the major axis 55 of the array.

FIGS. 3-6 depict alternate embodiments of multi-core optical fibers. Like elements are identified with like reference numbers and the description thereof may be omitted. Referring to FIG. 3, multi-core optical fiber 30 includes a hexagonal close packed array 31 that is similar to the hexagonal close packed array 11 of FIGS. 1-2 but with the array expanded by adding an additional row 32 of rods 12. Each of the rods 12 of the third row 32 is a support rod 17 and each is aligned with one of the rods of the second row 22. Through such a configuration, further stability may be added to the array 31 in order to maintain the precise positioning of the optical waveguides 14. Buffer 33 surrounds and contacts the array 31.

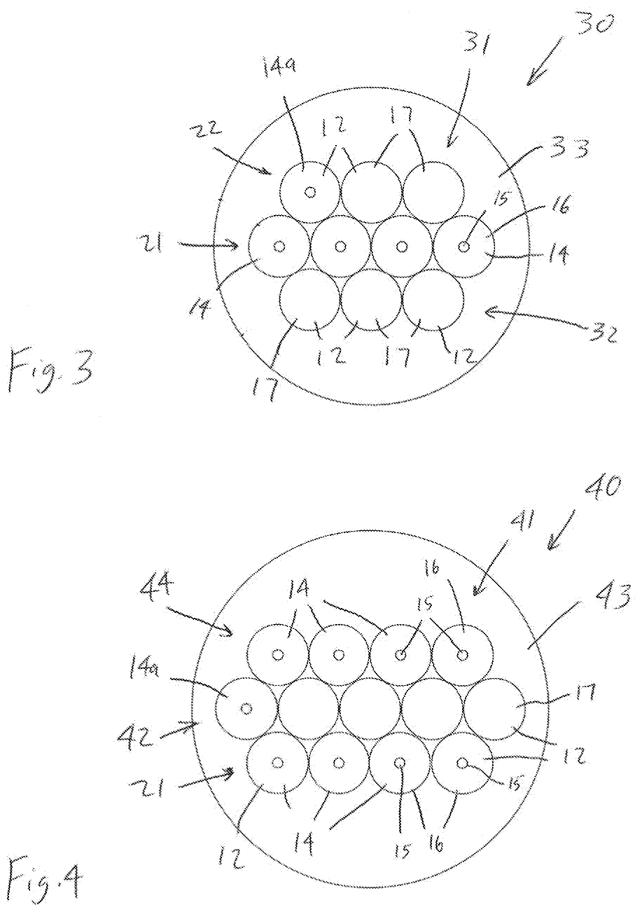

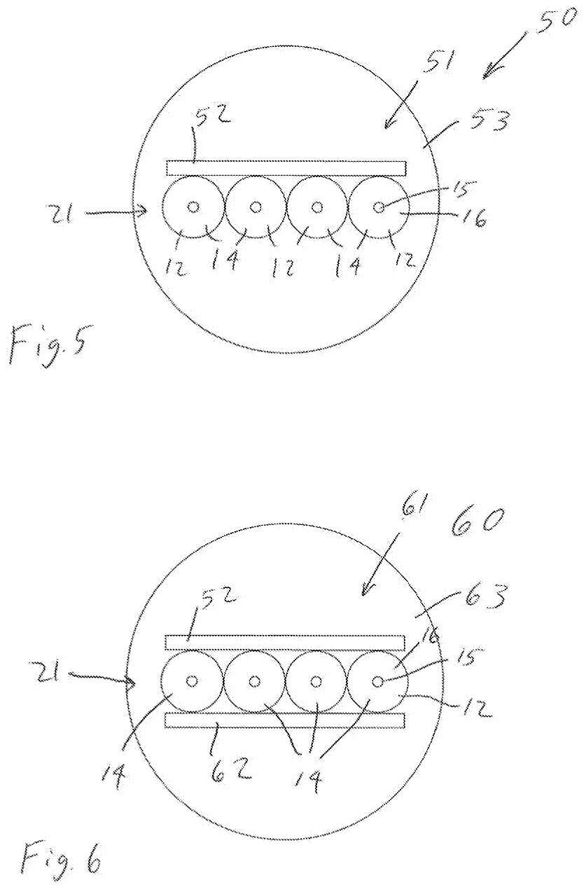

Multi-core optical fiber 40 depicted in FIG. 4 includes a hexagonal close packed array 41 that expands upon the array 11 depicted in FIGS. 1-2 by adding an additional row of optical waveguides 14 on the support structure defined by the second row 22 of rods 12 of FIGS. 1-2. The rods 12 of the first row 21 are all configured as optical waveguides 14. One of the rods 12 of the second row 42 is configured as a polarization waveguide 14a and the other rods are configured as support rods 17. It should be noted that the second row 41 has an additional rod 12 as compared to the number of rods in the first row 21.

A third row 44 of rods 12 is provided with each of the rods of the third row aligned with a rod 12 of the first row and also aligned with the intersection between adjacent rods of the second row 42 to form a hexagonal close packed array. Each of the rods 12 of the third row 44 is configured as an optical waveguide 14 and thus the third row defines a third linear array of rods and a second linear array of waveguides. As such, array 41 includes two linear arrays of optical waveguides 14 that are parallel to each other and positioned on opposite sides of the second row 42 of rods 12. Array 41 thus has two linear arrays of waveguides 14 with each linear array having four waveguides and may also include an orientation waveguide 14a, if desired. The orientation waveguide 14a is configured as a component of the second row 42 of rods 12 that functions as a linear support structure. Buffer 43 surrounds and contacts array 41.

As may be seen in FIGS. 1-4, each of the arrays 11, 31, and 41 include at least one linear array of waveguides 14 and at least one linear array of support rods 17 that define a linear support structure. The linear array of waveguides 14 and the linear support structure are positioned relative to each other to form a hexagonal close packed array. Each of the arrays 31 and 41 include a second linear array of rods 12. The second linear array of rods in array 31 provides a second linear support structure while the second linear array of rods in array 41 provides a second linear array of waveguides 14.

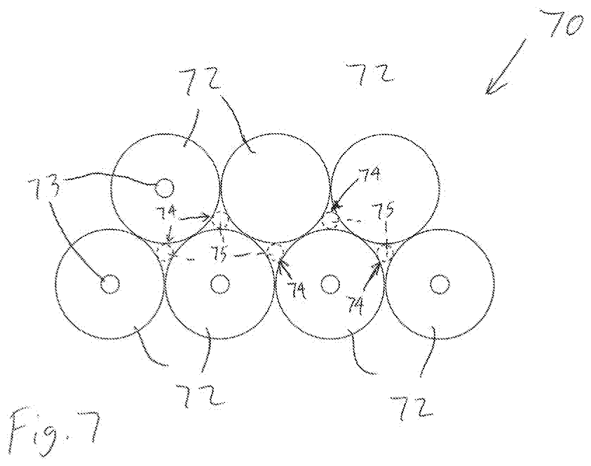

FIGS. 5-6 depict still further alternate embodiments of multi-core optical fibers. Multi-core optical fiber 50 (FIG. 5) has an array 51 of rods that includes a first row 21 of rods 12 and a support rod 52. Each rod 12 of the first row 21 has a circular cross-section and is configured as an optical waveguide 14 to define a linear array of optical waveguides. Support rod 52 has a rectangular cross-section and functions as a support rod rather than as an optical waveguide. Support rod 32 is fused to the waveguides 14 along one side of the linear array of waveguides 14. As such, array 51 is similar to array 11 but includes rectangular support rod 52 rather than the linear array of circular support rods 17 that define the linear support structure in FIGS. 1-2. Buffer 53 surrounds and contacts the array 51.

Multi-core optical fiber 60, depicted in FIG. 6, includes an array 61 similar to array 51 of FIG. 5 but includes a second support rod 62 with a rectangular cross-section that is fused to the first row 21 of optical waveguides 14 but on a side of the waveguides 14 opposite the support rod 52. As such, the array 61 includes a linear array of waveguides 14 with a linear support structure (i.e., the support rods 52 and 62) fused to opposite sides of the waveguides 14. Buffer 63 surrounds and contacts the array 61.

When forming an optical fiber, a preform having a cross-section substantially identical to the desired cross-section of the optical fiber is initially formed. Referring to FIG. 7, a cross-section of preform 70 used to form multi-core optical fiber 10 is depicted. Preform 70 includes preform rods 72 corresponding in location to each of the rods 12. When forming the preform 70, the preform rods 72 are formed of the desired materials and precisely positioned with the preform rods corresponding to rods 12 depicted in FIGS. 1-2. Some of the preform rods 72 include cores 73 corresponding to cores 15 of waveguides 14. The preform rods 72 are fused or otherwise secured to each other and sand or other material may be positioned within the interstitial gaps indicated at 74 in FIG. 7 between the preform rods 72. If desired, relatively small preform rods indicated in phantom at 75 may be placed within the interstitial gaps 74 to assist in maintaining the positions of the preform rods 72. After the preform 70 is formed, the optical fiber 10 may be formed by positioning the preform at the top of a draw tower (not shown) and heating the preform within an in-line furnace (not shown). After the array 11 is drawn to the desired size, the buffer 13 is applied and then cured to form the multi-core optical fiber 10.

The multi-core optical fibers 10, 30, 40, 50, and 60 described above have many advantages over existing multi-core optical fibers in which the cores are surrounded by a cylindrical support tube and thus the glass components have a circular cross-section. Since the arrays 11, 31, 41, 51, and 61 of the optical fibers 10, 30, 40, 50, and 60 include a major axis 55 and a minor axis 56, bending of the optical fiber most easily occurs generally along the minor axis. As a result, distortion within the waveguides 14 caused by bending of the optical fiber will be consistent between adjacent waveguides. Further, since the direction of such bending may be anticipated, compensation for any distortion caused by such bending may be more easily achieved.

More specifically, an existing multi-core optical fiber having a circular cross-section may bend in any direction and such bending may affect the waveguide within the fiber and in an inconsistent manner. For example, a multi-core fiber in which the glass components have a circular cross-section (i.e., the fiber includes a structural support tube surrounding the cores) and a linear array of waveguides may bend at any orientation relative to the linear array. As a result, unless the optical fiber is bent in a direction perpendicular to the linear array of waveguides, the bending of the waveguides will be inconsistent and thus the optical characteristics of each waveguide may be affected differently by the bend.

In contrast, with the multi-core optical fibers 10, 30, 40, 50, and 60 disclosed herein, the optical fibers will bend in a consistent manner in a direction generally orthogonal to the major axis 55 or along the minor axis 56 so that the bending of the optical fiber will have an equal or consistent effect on each of the waveguides 14. This minimizes strain-induced polarization effects that can diminish signal integrity. Still further, since the direction of bending will be known, certain types of distortion may be anticipated and systems in which the multi-core optical fiber is used may be configured to compensate for those types of distortion caused by such bending.

The lack of a glass structural support tube around the rods 12 of the multi-core optical fibers 10, 30, 40, 50, and 60 of the present disclosure also permit the optical fiber to be bent in a smaller radius as compared to a multi-core optical fiber having the same rods plus a glass support tube surrounding the rods. In other words, the cross-sectional structure of the disclosed embodiments in which the optical fiber 10, 30, 40, 50, and 60 bends orthogonal to the major axis 55 causes a reduction in the mechanical stress caused by bending of the waveguides 14. Reductions in stress on the optical fibers is desirable as such stress decreases the optical performance of the optical fiber.

The multi-core optical fibers 10, 30, 40, 50, and 60 of the present disclosure also simplify connection and termination of the optical fibers as compared to existing multi-core optical fibers in which the glass components have a circular cross-section. Since the multi-core optical fibers 10, 30, 40, 50, and 60 of the present disclosure will generally bend orthogonal to the major axis 55, such bending action may be used to determine the orientation of the waveguides 14. More specifically, since the waveguides 14 are configured in a linear array generally perpendicular to the minor axis 56, the orientation of the linear array of waveguides may be determined in a passive manner (i.e., without projecting or sending light through the waveguides) by merely bending the optical fiber. This passive manner of determining the position of the waveguides 14 is substantially less complicated and time consuming than actively determining the position of the waveguides within the multi-core optical fiber of the prior art in which the glass components have a circular cross-section.

In some instances, the array of waveguides and support structure may be symmetrical resulting in a major axis 55 that is also a neutral axis of the structure. For example, in FIG. 3, the first row 21 of rods 12 is along the major axis and the symmetrical nature of the first row 21, second row 22, and third row 32 of array 31 results in the major axis coinciding with the neutral axis. Similarly, in FIG. 4, the first row 42 of rods 12 is along the major axis and the symmetrical nature of the first row 21, second row 22, and third row 42 of array 41 results in the major axis coinciding with the neutral axis. In FIG. 6, the row 21 of rods 12 is along the major axis and configuration of the row of rods, the first support rod 52, and the second support rod 62 result in the major axis coinciding with the neutral axis.

The performance of polarization maintaining optical fibers or waveguides is typically dependent upon minimizing strain on the optical fibers or waveguides. By configuring the rods 12 that are along the major axis and the neutral axis as polarization maintaining optical fibers or waveguides, the strain on the polarization maintaining waveguides may be minimized. Accordingly, it may be desirable to utilize polarization maintaining optical fibers or waveguides along the major axis (which coincides with the neutral axis) of the multi-core optical fibers 30, 40 and 60 to isolate such polarization maintaining optical fibers or waveguides from strain-induced signal degradation.

In some instances, it may be desirable to configure the multi-core optical fibers to increase the security of the signals being transmitted through the waveguides 14 thereof. For example, it is known that bending certain waveguides will cause leakage of light from the waveguide. Such waveguides that permit leakage are referred to herein as standard waveguides. It is further known to configure certain other waveguides such that they less-readily leak light upon bending of the waveguide. Such waveguides that restrict light leakage are referred to herein as bend-insensitive waveguides.

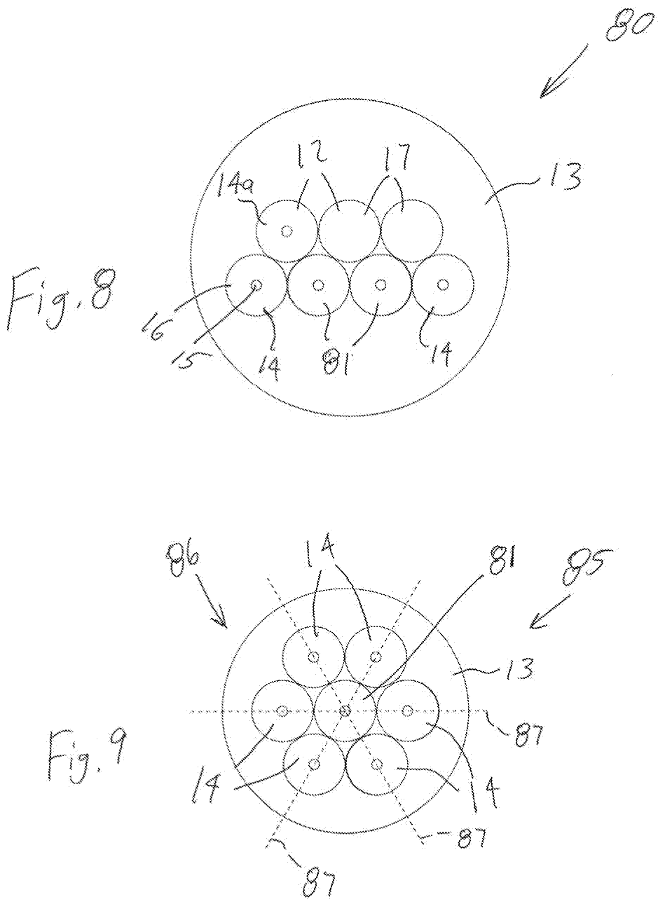

Referring to FIG. 8, a multi-core optical fiber 80 with enhanced security is depicted. The structure of multi-core optical fiber 80 is similar to that of multi-core optical fiber 10 of FIG. 1 and like elements are identified with like reference numbers. In multi-core optical fiber 80, the waveguides 14 are standard waveguides and thus bending of the waveguide will readily permit light to pass through the cladding adjacent the bent portion so that light leaks from the waveguide. One or more of the waveguides are configured as bend-insensitive waveguides 81 and thus prevent or minimize the amount of light that passes through the cladding or leaks from a bent portion of the waveguide. Through such a configuration, the standard waveguides 14 permit a sufficient amount of light to leak, when bent, to obscure the leakage of light from the bend-insensitive waveguides 81.

A multi-core optical fiber may have any desired combination of standard waveguides 14 and bend-insensitive waveguides 81. In other words, any of the standard waveguides 14 of any of the multi-core optical fibers 10, 30, 40, 50 and 60, as well as any other configurations of multi-core optical fibers, may be replaced by bend-insensitive waveguides 81. The arrangement (i.e., positions and mix) of standard waveguides 14 and bend-insensitive waveguides 81 may be determined based upon any number of factors including the types of signals being sent, the desired degree of security, and the desired fiber interconnection.

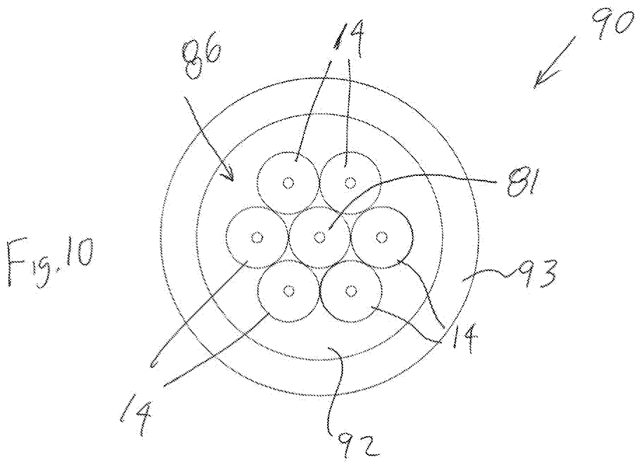

FIG. 9 depicts another example of a multi-core optical fiber 85. In one embodiment, an array of waveguides 86 includes a bend-insensitive waveguide 81 positioned in the center of a ring of standard waveguides 14. Such configuration may be advantageous because any light escaping from the bend-insensitive waveguide 81 is surrounded and obscured by the light escaping from the surrounding standard waveguides 14.

Multi-core optical fiber 85 is capable of being bent along three major axes, each being indicated at 87, that are 120 degrees apart. By positioning the bend-insensitive waveguide 81 in the center of the array of waveguides, the bend-insensitive waveguide 81 will always be along one of the major axes 87 so that it will be bent less than the standard waveguides 14 that are not positioned along the major axis. As a result, regardless of the orientation of the multi-core optical fiber 85, any optical signals escaping from the bend-insensitive waveguide 81 will be obscured by the greater signals escaping from the standard waveguides 14 that are not located along the major axis 87 about which the optical fiber is being bent.

In some embodiments, standard waveguides 14 and bend-insensitive waveguides 81 may be used in a multi-core optical fiber having a cylindrical support tube such that the glass components have a circular cross-section. For example, as depicted in FIG. 10, a multi-core optical fiber 90 includes a waveguide array 91 identical to that of FIG. 9 with the waveguide array including a plurality of standard waveguides 14 surrounding a single bend-insensitive waveguide 81. However, the multi-core optical fiber 90 includes a glass cylindrical support tube 92 surrounding and engaging or contacting the waveguide array 91 and a buffer 93 surrounding and engaging or contacting the support tube. With such a configuration, the multi-core optical fiber 90 will be able to bend in any direction as a result of the glass support tube 92 but any light escaping from the bend-insensitive waveguide 81 will be obscured by light escaping from the standard waveguides 14.

In the embodiments depicted in FIGS. 9 and 10, if desired, the bend-insensitive waveguide 81 may be replaced by a polarization maintaining optical fiber or waveguide since the symmetrical array results in the major axis being coincident with the neutral axis, thus avoiding or minimizing strain-induced signal degradation.

In an embodiment, a mutually fused array of optical fibers or waveguides such as those of a multi-core optical waveguide may be provided for enhanced security. The array has peripheral fibers or waveguides at or near the outside edge of the array and inner fibers or waveguides that are closer to the center of the array than the peripheral fibers or waveguides. The inner fibers or waveguides are constructed in a manner such that they less-readily leak light than the peripheral fibers or waveguides do when the array is bent.

In some embodiments, some or all of the inner fibers or waveguides are constructed to minimize the leakage of light when bent. In some embodiments, some or all of the peripheral fibers or waveguides are constructed to sufficiently leak light, when bent, to obscure the leakage of light from some or all of the inner fibers. Some or all of the inner fibers or waveguides may be comprised of bend-insensitive fiber. Some or all of the peripheral fibers or waveguides may be constructed of bend-sensitive fiber.

In the embodiments depicted in FIGS. 9 and 10, information conveyed by light transmitted via the central fiber or waveguide 81 can be made more secure by also transmitting light via one or more of the surrounding fibers or waveguides 14. If this array of optical fibers or waveguides is tapped by bending the array, the light leaked from one or more of the surrounding fibers 14 can be used to hide or obscure any light leaked from the central fiber or waveguide 81.

While a preferred embodiment of the Present Disclosure is shown and described, it is envisioned that those skilled in the art may devise various modifications without departing from the spirit and scope of the foregoing Description and the appended Claims.

What is claimed is:

1. A multi-core optical fiber comprising:
a plurality of optical waveguides, each optical waveguide having a length, a core and a cladding layer surrounding the core, each optical waveguide being at least partially fused to an adjacent optical waveguide along the length thereof, at least some of the optical waveguides being aligned to form a linear array, the linear array having a major axis generally parallel to the linear array and a minor axis generally perpendicular to the major axis;
a linear support structure fused to the linear array of optical waveguides along the length of the optical waveguides; and
the optical waveguides and the linear support structure defining an outer perimeter, a buffer engaging and surrounding the outer perimeter, the buffer having a buffer modulus of elasticity substantially less than a waveguide modulus of elasticity of each of the waveguides.

2. The optical fiber of claim 1, wherein the linear support structure is formed from a single component.

3. The optical fiber of claim 2, wherein the linear support structure has a rectangular cross-section.

4. The optical fiber of claim 1, wherein the linear support structure is formed from a plurality of components fused together.

5. The optical fiber of claim 4, wherein the each of the components has a circular cross-section.

6. The optical fiber of claim 1, wherein each of the optical waveguides and the support structure is made from glass.

7. The optical fiber of claim 1, wherein the optical fiber is devoid of a glass support tube encircling the outer perimeter.

8. A multi-core optical fiber comprising:
a plurality of silica rods, each rod being at least partially fused to an adjacent rod along a length thereof to define a rod array, at least some of the rods being optical rods and having a core and a cladding surrounding the core to define an optical waveguide;
at least some of the optical waveguides forming a linear array of optical waveguides, the rod array having a major axis generally parallel to the linear array and the rod array having a minor axis generally perpendicular to the major axis;
the silica rods defining an outer cross-sectional perimeter, at least a portion of the outer cross-sectional perimeter being defined by at least some of the optical rods; and
a buffer engaging and surrounding the outer cross-sectional perimeter, the buffer having a buffer modulus of elasticity substantially less than a rod modulus of elasticity of each of the silica rods.

9. The optical fiber of claim 8, wherein the optical fiber is devoid of a glass support tube encircling the outer perimeter.

10. The optical fiber of claim 8, wherein at least one optical waveguide is a bend-insensitive waveguide.

11. The optical fiber of claim 10, wherein the bend-insensitive waveguide is disposed along the major axis.

12. The optical fiber of claim 11, further comprising a glass support tube encircling and engaging the outer perimeter.

13. The optical fiber of claim 12, further comprising a buffer engaging and surrounding the glass support tube, the buffer having a buffer modulus of elasticity substantially less than a waveguide modulus of elasticity of each of the silica rods and the glass support tube.

14. The optical fiber of claim 8, wherein the major axis is coincident with a neutral axis of the rod array.

15. The optical fiber of claim 14, wherein at least one optical waveguide disposed along the neutral axis is a polarization maintaining waveguide.

16. The optical fiber of claim 8, wherein at least some of the support rods have a circular cross-section.

17. The optical fiber of claim 8, further comprising a linear support structure fused to the linear array of optical waveguides.

18. The optical fiber of claim 17, further comprising an orientation waveguide disposed along the linear support structure.

19. The optical fiber of claim 8, wherein the buffer modulus of elasticity is approximately 50,000 psi or less.

20. A multi-core glass optical fiber comprising:
a plurality of glass optical waveguides, each optical waveguide having a length, a core and a cladding layer, the cladding layer having an annular cross section surrounding and co-axial with its core, each optical waveguide being at least partially fused to an adjacent optical waveguide along the length thereof, at least some of the optical waveguides being aligned to form a linear array, the linear array having a major axis generally parallel to the linear array and a minor axis generally perpendicular to the major axis;
a glass linear support structure fused to the linear array of optical waveguides along the length of the optical waveguides and along a side of the linear array and generally parallel to the major axis;
the optical waveguides and the linear support structure defining an outer perimeter, the optical fiber being devoid of a glass support tube encircling the outer perimeter; and
a buffer engaging and surrounding the outer perimeter, the buffer having a buffer modulus of elasticity substantially less than a waveguide modulus of elasticity of each of the waveguides.

21. The optical fiber of claim 20, wherein the linear support structure is formed from a single component having rectangular cross-section.

22. The optical fiber of claim 20, wherein the linear support structure is formed from a plurality of components fused together, and each of the components has a circular cross-section.

23. The optical fiber of claim 20, wherein the linear array includes at least four optical waveguides

24. The optical fiber of claim 23, wherein the buffer is formed of UV cured acrylate material.
